(19) United States
(12) Patent Application Publication
(10) Pub. No.: US 2019/0224874 A1
(43) Pub. Date: Jul. 25, 2019

(54) Bidirectional Shaving Device

(71) Applicant: Edgewell Personal Care Brands, LLC, Chesterfield, MO (US)

(72) Inventors: Alan Blatter, Milford, CT (US); Samantha Cabrera, Milford, CT (US)

(21) Appl. No.: 16/336,553

(22) PCT Filed: Sep. 8, 2017
(86) PCT No.: PCT/US2017/050612

§ 371 Date: Mar. 26, 2019

Related U.S. Application Data
(60) Provisional application No. 62/394,374, filed on Sep. 14, 2016.
(60) Provisional application No. 62/398,586, filed on Sep. 23, 2016.

(51) Int. Cl. B26B 21/52; B26B 21/40

(52) U.S. Cl. CPC B26B 21/521; B26B 21/4018; B26B 21/443; B26B 21/522; B26B 21/4043; B26B 21/4025

(57) ABSTRACT

A pivotal bi-directional shave cartridge configured to shave a skin surface in a first and a second opposite direction is provided. The shave cartridge includes a housing, a first blade group, a second blade group, and a guard bar disposed between the two blade groups. The first blade group includes at least a first razor blade having a cutting edge. The second blade group includes at least a first razor blade having a cutting edge. A lengthwise extending center plane is disposed equidistant between the cutting edge of the first razor blade of the first blade group and the cutting edge of the first razor blade of the second blade group. The center plane is perpendicular to a reference plane that is tangential to the cutting edge of the first razor blade of the first blade group and the cutting edge of the first razor blade of the second blade group. The shave cartridge is configured to pivot about a pivot axis disposed between the center plane and a plane tangential to the cutting edge of the first razor blade of the first blade group parallel to the center plane.

This application in a 371 international of Application No. PCT/US2017/050612, filed on Sep. 9, 2017, which claims benefit of U.S. Provisional Application No. 62/394,374, filed on Sep. 14, 2016 and U.S. Provisional Application No. 62/398,586, filed on Sep. 23, 206

### BACKGROUND OF THE INVENTION

### 1. Field of the Invention

The invention relates generally to shaving devices, and more particularly to bidirectional shaving devices.

### 2. Background Information

Wet shaving devices typically comprise a single or multiple blades aligned in one direction such that the shaving devices are unidirectional (i.e., razor is configured such that the blades can only cut along one direction). A drawback with unidirectional shaving devices is that the razor must be lifted off of a hirsute surface during a return stroke in order to properly position the razor for a subsequent cutting stroke. The return stroke increases the time required for shaving large hirsute surfaces such as, for example, the legs of a user. A second drawback is that the scraping of the skin during the initialization of each cutting stroke can tend to cause discomfort.

### SUMMARY OF THE INVENTION

According to a first aspect of the present invention, a pivotal bi-directional shave cartridge configured to shave a skin surface in a first direction and a second direction, which second direction is substantially opposite the first direction, is provided. The shave cartridge includes a housing, a first blade group, a second blade group, and a guard bar. The housing has a width, a length, a shave side, and a handle attachment side. The first blade group includes at least a first razor blade having a cutting edge. The first blade group is configured to shave the skin surface when the shave cartridge is translated in the first direction. The second blade group includes at least a first razor blade having a cutting edge. The second blade group is configured to shave the skin surface when the shave cartridge is translated in the second direction. The guard bar is disposed between the first blade group and the second blade group. A lengthwise extending center plane is disposed equidistant between the cutting edge of the first razor blade of the first blade group and the cutting edge of the first razor blade of the second blade group. The center plane is perpendicular to a reference plane that is tangential to both the cutting edge of the first razor blade of the first blade group and the cutting edge of the first razor blade of the second blade group. The shave cartridge is configured to pivot about a pivot axis. The pivot axis is disposed offset from the center plane and between the center plane and a plane tangential to the cutting edge of the first razor blade of the first blade group, which plane is parallel to the center plane.

In a further embodiment of the foregoing aspect the pivot axis is closer to the cutting edge of the first razor blade of the first blade group than the cutting edge of the first razor blade of the second blade group.

In a further embodiment of any of the embodiments of the foregoing aspect, a distance between the pivot axis and the cutting edge of the first razor blade of the first blade group is less than a distance between the center plane and the cutting edge of the first razor blade of the first blade group.

According to a second aspect of the present invention, the pivot axis is disposed offset from the center plane and between the center plane and a plane tangential to the cutting edge of the second razor blade of the first blade group, which plane is parallel to the center plane. In a further embodiment of any of the embodiments of this aspect, the pivot axis is closer to the cutting edge of the first razor blade of the first blade group than the cutting edge of the second razor blade of the first blade group.

According to a third aspect of the present invention, the pivot axis is disposed offset from the center plane and between the center plane and a plane tangential to the cutting edge of the last razor blade of the first blade group, which plane is parallel to the center plane. In a further embodiment of any of the embodiments of this aspect, the pivot axis is closer to the cutting edge of the first razor blade of the first blade group than the cutting edge of the last razor blade of the first blade group.

In a further embodiment of any of the foregoing aspects, the pivot axis is disposed a distance no more than 0.5 mm from the reference plane in a direction toward the handle attachment side.

In a further embodiment of any of the embodiments of any of the foregoing aspects, the first blade group includes a first number of razor blades and the second blade group includes a second number of razor blades, and the first number of razor blades is different than the second number of blades. In some embodiments, the first number of razor blades is greater than the second number of razor blades.

In a further embodiment of any of the embodiments of any of the foregoing aspects, at least one razor blade of the second blade group includes a skin engaging member attached to the razor blade.

In a further embodiment of any of the embodiments of any of the foregoing aspects, at least one razor blade of the first blade group includes a skin engaging member attached to the razor blade.

In a further embodiment of any of the embodiments of any of the foregoing aspects, the guard bar includes surface features, which features are disposed between the pivot axis and the second blade group. In some embodiments, the surface features extend through the reference plane.

In a further embodiment of any of the embodiments of any of the foregoing aspects, the pivot axis is disposed in the reference plane.

In a further embodiment of any of the embodiments of any of the foregoing aspects, the pivot axis is disposed above the reference plane.

In a further embodiment of any of the embodiments of any of the foregoing aspects, the first blade group, the second blade group, and the guard bar are mounted within a razor cartridge, which razor cartridge is mounted within the housing.

In a further embodiment of any of the embodiments of any of the foregoing aspects, the shave cartridge further comprises a forward cap and an aft cap.

In a further embodiment of any of the embodiments of any of the foregoing aspects, the at least first razor blade having a cutting edge of the first blade group is a plurality of razor blades each having a cutting edge, and the cutting edges of the razor blades are co-planar within a first plane.

In a further embodiment of any of the embodiments of any of the foregoing aspects, the at least first razor blade having a cutting edge within the second blade group is a plurality of razor blades each having a cutting edge, and the cutting edges of the razor blades are co-planar within a second plane.

In a further embodiment of any of the embodiments of any of the foregoing aspects, the cutting edge of the at least first razor blade of the first blade group is oriented such that a line extending through a widthwise centerline of the first razor blade of the first blade group extends generally in a direction toward the second blade group.

In a further embodiment of any of the embodiments of any of the foregoing aspects, the cutting edge of the at least first razor blade of the second blade group is oriented such that a line extending through a widthwise centerline of the first razor blade of the second blade group extends generally in a direction toward the first blade group.

In a further embodiment of any of the embodiments of any of the foregoing aspects, the at least first razor blade having a cutting edge of the first blade group is a plurality of razor blades each having a cutting edge, and the cutting edges of the razor blades of the first blade group are each oriented such that a line extending through a widthwise centerline of each razor blade of the first blade group extends generally in a direction toward the second blade group.

In a further embodiment of any of the embodiments of any of the foregoing aspects, the at least first razor blade having a cutting edge of the second blade group is a plurality of razor blades each having a cutting edge, and the cutting edges of the razor blades of the second blade group are each oriented such that a line extending through a widthwise centerline of each razor blade of the second blade group extends generally in a direction toward the first blade group.

### BRIEF DESCRIPTION OF THE DRAWINGS

FIG. 1A is a planar rear view of a shaving device that includes an embodiment of a shave cartridge.

FIG. 1B is a planar front view of the shaving device shown in FIG. 1A.

FIG. 1C is a planar side view of the shaving device shown in FIG. 1A.

FIG. 2 is a perspective view of a shave cartridge embodiment.

FIG. 3 is a sectional view of the shave cartridge embodiment shown in FIG. 2.

FIG. 4 is a sectional view of another shave cartridge embodiment.

FIG. 5 is a sectional perspective view of a shave cartridge embodiment.

FIG. 6 is a diagrammatic partial view of a shave cartridge embodiment.

FIG. 7 is a perspective view of a razor cartridge embodiment.

FIG. 8 is a perspective view of a razor cartridge embodiment.

FIG. 9 is a partial sectional view of a razor cartridge embodiment.

FIG. 10 is a partial sectional view of a razor cartridge embodiment.

FIG. 11A is a perspective view of a blade retainer embodiment.

FIG. 11B is a perspective view of the blade retainer embodiment shown in FIG. 11A.

FIG. 11C is a planar view of the blade retainer embodiment shown in FIGS. 11A and 11B.

FIG. 11D is a planar view of the blade retainer embodiment shown in FIGS. 11A and 11B.

FIG. 12 is a partial sectional view of a razor cartridge embodiment.

FIG. 13 is an enlarged partial view of the shaving device shown in FIG. 1A.

FIG. 14A is a diagrammatic planar view of a shave cartridge attachment mechanism portion disposed on a handle.

FIG. 14B is a diagrammatic side view of the shave cartridge attachment mechanism portion disposed on a handle shown in FIG. 14A.

FIG. 15 is a diagrammatic side view of a blade embodiment.

FIG. 16 is a diagrammatic side view of a blade embodiment.

### DETAILED DESCRIPTION

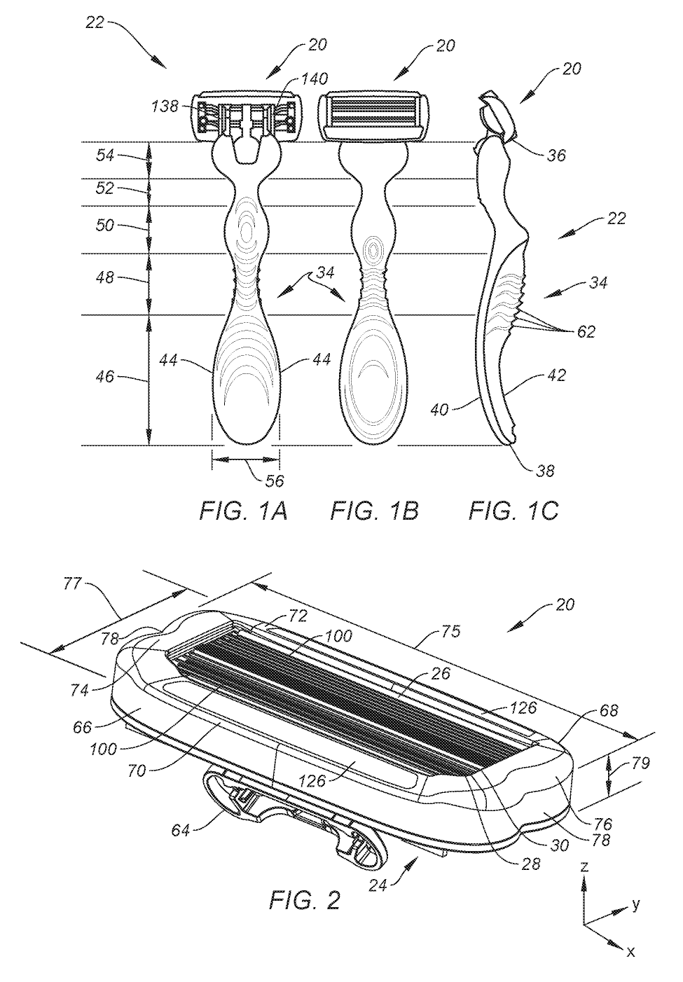

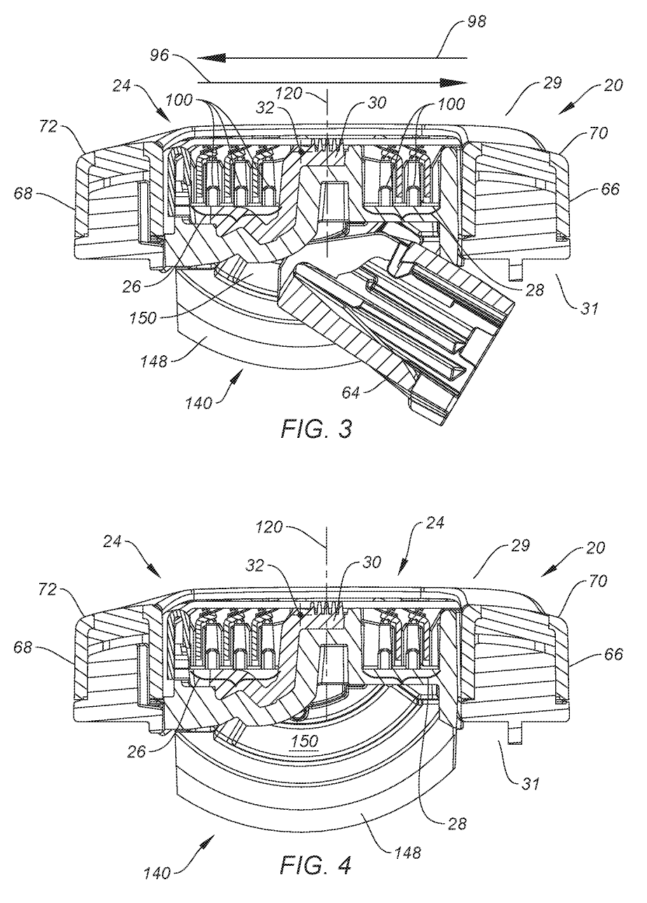

Referring to FIGS. 1-5, according to an aspect of the present invention a shave cartridge 20 for a shaving device 22 is provided that comprises a housing 24, a first blade group 26, a second blade group 28, and a guard bar 30. As will be explained below, the shave cartridge 20 is configured to have a non-centered lengthwise extending pivot axis 32 (see FIGS. 3 and 4) about which the shave cartridge 20 can pivot. In particular, the pivot axis 32 allows the shave cartridge 20 to pivot (e.g., from a normal position assumed at rest) to an appropriate orientation to permit the shave cartridge to maintain contact with the skin and follow any skin surface undulations that may be encountered during the shave stroke.

As shown in FIGS. 1A-1C, the shaving device 22 includes a handle 34. The guard bar 30 is disposed between the first blade group 26 and the second blade group 28. The shave cartridge 20 may be described as having a shave side 29 and a handle attachment side 31 opposite one another. The shave cartridge 20 may be a disposable cartridge for use with a reusable handle 34 (e.g., a new disposable shave cartridge 20 may be attached to the reusable handle 34, and subsequently removed), or it may be affixed to a handle 34 to form a unitary disposable razor.

A handle 34 embodiment that may be used with the present shave cartridge 20 is shown in FIGS. 1A-IC. The handle 34 may be configured to be attachable to a disposable shave cartridge 20 (e.g., as described herein) or may be configured for permanent attachment to a shave cartridge 20. The handle 34 includes a first end 36 configured for attachment to the shave cartridge 20 (either selectively attachable or permanently attachable), a second end 38 disposed opposite the first end 36, a top surface 40, a bottom surface 42, and lateral side surfaces 44. The handle 34 includes first handle portion 46, a second handle portion 48, a third handle portion 50, a fourth handle portion 52, and a fifth handle portion 54. The aforesaid handle portions 46-54 are disposed in linear order beginning with the first handle portion 46 disposed adjacent the second end 38, and ending with the fifth handle portion 54 disposed adjacent the first end 36. Each handle portion 46-54 includes a width 56, i.e. a maximum width or a minimum width depending if the respective handle portion is outwardly or inwardly extending. Each handle portion 46-54 is arcuately shaped, and the arcuate shapes transition between adjacent portions. The width of the second handle portion 48 is less than those of the first and third handle portions 46, 50. Consequently, the width of the handle 34 decreases from the first handle portion 46 through at least a portion of the second handle portion 48 and then increases again as it transitions into the third handle portion 50. The width of the fourth handle portion 52 is less than those of the third and fifth handle portions 50, 54. Consequently, the width of the handle 34 decreases from the third handle portion 50 through at least a portion of the fourth handle portion 52 and then increases again as it transitions into the fifth handle portion 54. The undulating width of the handle 34 created by the varying portion widths provides narrow portions (i.e., the second and fourth handle portions 48, 52) disposed between wide portions (i.e., the first, third and fifth handle portions 46, 50, 54) that enable the user to grip the handle 34 in a manner that inhibits grip slippage along the length of the handle 34. In addition as can be seen in the side view of FIG. 1C, the first through third handle portions 46-50 have an arcuately shaped top surface 40 that ergonomically fits within the palm of the user's hand. The top surface 40 of the fourth and fifth handle portions 52, 54 is also arcuately shaped, but the top surface curvature in the fourth and fifth handle portions 52, 54 curves away from the top surface curvature within the third handle portion 50. The variation in the top surface curvature throughout the handle portions also enables the user to grip the handle 34 in a manner that inhibits grip slippage along the length of the handle 34. In some embodiments, one or more of the portions may include ribs 62 (or other geometric features) extending out from the respective surfaces to further enhance the user's ability to grip the handle 34. The above-described geometry of the handle 34 makes the handle 34 ergonomic and easily grasped, and thereby facilitates the operation of the shave cartridge 20 in the forward and aft stroke directions as will be described below.

The handle 34 and shave cartridge 20 of the present shaving device 22 may be attached to one another in a variety of different manners, and is not therefore limited to the examples provided herein. The shave cartridge 20 embodiments shown in FIGS. 2 and 3, for example, include a handle connector portion 64 that is configured to attach to a handle 34. The housing 24 is allowed to pivot relative to the handle connector portion 64 (and therefore the handle 34) about the non-centered lengthwise extending pivot axis 32. The shave cartridge 20 embodiment shown in FIG. 4 does not include a handle connector portion 64, but rather is configured to attach directly to a handle 34 as will be described below.

The shave cartridge 20 is configured to be translated (“stroked”) across a hirsute skin surface (referred to hereinafter as the “surface”) in a first stroke direction and a second stroke direction that is substantially opposite the first stroke direction. To facilitate the description herein, the first stroke direction will be referred to hereinafter as a “forward” stroke direction, and the second stroke direction will be referred to as a “reverse” stroke direction. The forward stroke direction may also be referred to as a “pull” stroke since the shave cartridge 20 follows the handle 34 in this direction, and the reverse stroke direction may also be referred to as a “push” stroke since the shave cartridge 20 leads the handle 34 in this direction. As will be evident from the present description, the present shave cartridge 20 allows the user to “push” and “pull” the shave cartridge 20 across the skin surface to be shaved safely and efficiently without having to lift the shave cartridge 20 from the surface.

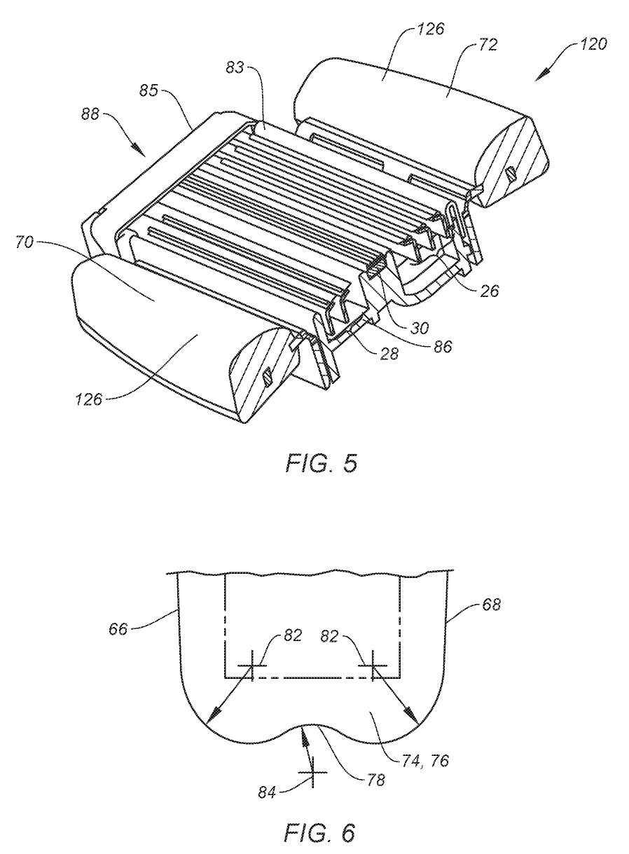

The housing 24 includes a forward edge surface 66, an aft edge surface 68, a forward cap 70, and an aft cap 72. In some embodiments, the housing 24 may further include a first lateral portion 74 and a second lateral portion 76. The embodiment shown in FIG. 2, for example includes first and second lateral portions 74, 76. The embodiment shown in the sectioned view of FIG. 5 does not include lateral portions. To facilitate the description herein, the shave cartridge 20 (and therefore the housing 24) may be described in terms of orthogonal axes. For example, the shave cartridge 20 may be described as having a length 75 that extends in an X-axis direction, a width 77 that extends in a Y-axis direction, and a depth 79 that extends in a Z-axis direction. In some embodiments, at least portions of the elements that form the housing 24 may be formed (e.g. injection molded) from a relatively rigid polymer. A non-limiting example of such a polymer is NORYL (a homogeneous mixture of polyphenylene ether (PPE) and polystyrene PS), specifically the material designated PX-5511, manufactured by SABIC Innovative Plastics IP B.V. In some embodiments (e.g., as shown in FIGS. 1 and 2), the housing 24 is generally rectangular. The housing 24 is not, however, limited to a rectangular shape; e.g., embodiments of the housing 24 may be oval, generally rectangular with rounded corners, etc.

In some embodiments (e.g., FIGS. 2 and 6), the housing 24 may include a shape that includes indented lateral portions 78. The indented lateral portions 78 can advantageously provide relatively large curvatures (e.g., radii) in the regions where the forward and aft caps 70, 72 meet the lateral portions 74, 76, with a relatively small or no increase in the overall length 75 of the shave cartridge housing 24. For example as is diagrammatically illustrated in FIG. 6, at the regions where a forward or aft cap 70, 72 meets a lateral portion 74, 76, the curvature at each of those regions is centered at a point 82 inside the cartridge, and the indented region 78 of the lateral portion disposed there between is centered at a point 84 outside the shave cartridge 20. A shorter length shave cartridge 20 according to these embodiments enables the shave cartridge 20 to access skin contours (e.g., armpit areas, bikini area, etc.) that may not otherwise be easily accessible.

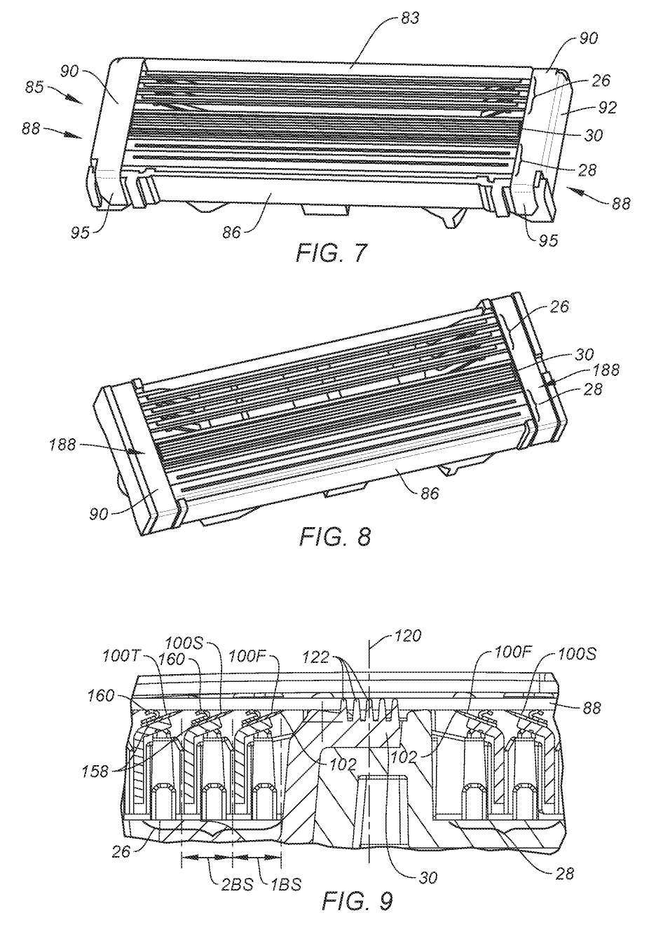

The first blade group 26, second blade group 28, and the guard bar 30 are mounted within the housing 24 either individually or in some combination. For example, the first blade group 26, second blade group 28, and the guard bar 30 may be mounted individually within the shave cartridge 20. Alternatively, the first blade group 26, second blade group 28, and the guard bar 30 may be disposed within a razor cartridge 86 (e.g., see FIGS. 5, 7, and 8), and the razor cartridge 86 may be mounted within the shave cartridge 20. FIGS. 7 and 8 show razor cartridge 86 embodiments that can be mounted within a present shave cartridge 20. In such embodiments, the razor cartridge 86 may be configured to have a generally rectangular shape and may be mounted within a shave cartridge 20 having a non-rectangular shape (e.g., oval) as described above.

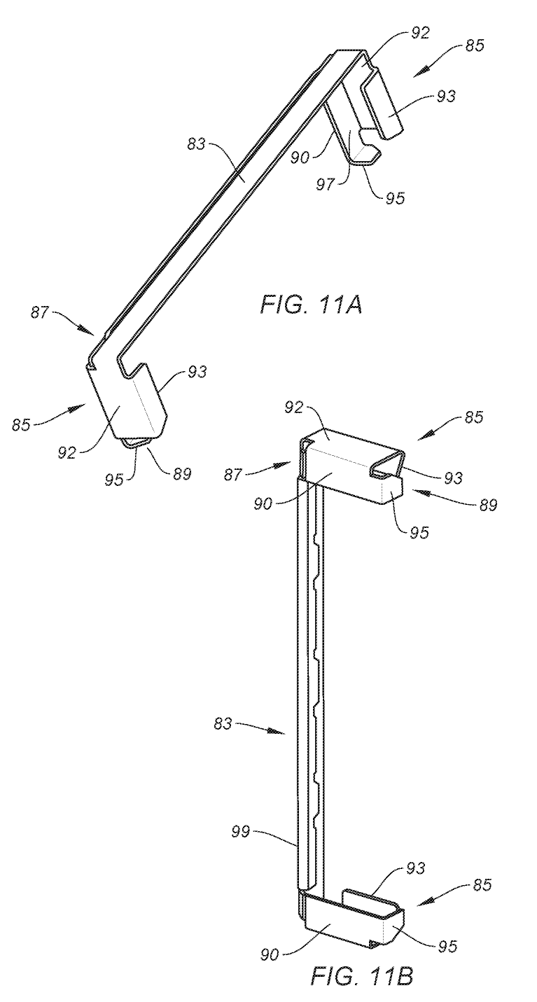

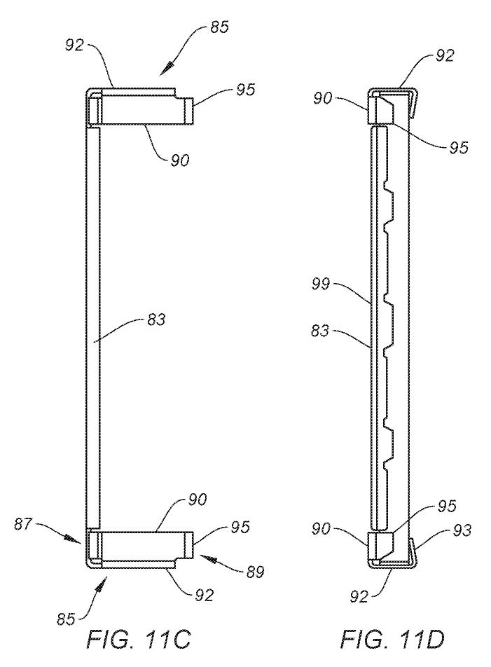

In some embodiments, the razor cartridge 86 may include a blade retainer 88. The non-limiting example of a blade retainer 88 shown in FIGS. 11A-11D is a unitary structure having end portions 85 connected to one another by a connector portion 83. The end portions 85 are configured to retain the blades within the first and second blade groups 26, 28. The configuration of the end portions 85 can vary to accommodate different cartridge applications. In the embodiment shown, each end portion 85 includes a first end 87, a second end 89, a first flange 90, a second flange 92, a first tab 93, and a second tab 95. The first flange 90 includes a datum surface 97. The connector portion which may have a J-shape cross-section (e.g., see FIGS. 3 and 4) or a U-shape cross-section, is connected to each end portion 85 proximate the first end 87 of each respective end portion 85. The connector portion 83 includes an exposed surface 99 that, depending on the particular cartridge 20, may be positioned to engage the user's skin surface during a shaving stroke. The first tab 93 is spaced apart from and generally opposite the first flange 90, and the second tab 95 is spaced apart from and generally opposite the first end 87 of the respective end portion 85. The first and second tabs 93, 95 may be configured to locate and/or retain the blade retainer 88 within the cartridge 20. The blade retainer 88 shown in FIGS. 11A-11D is a non-limiting example of a blade retainer 88 and alternative embodiments may be used in place thereof. For example, the razor cartridge 86 shown in FIG. 8 has independent blade retainers 188 mounted adjacent each lengthwise end of the razor cartridge 86. These independent blade retainers 188 (e.g., without a connector portion 83 extending there between) may be configured in a manner similar to the end portions 85 described above. U.S. Pat. No. 8,307,553, which is incorporated by reference herein in its entirety, discloses similar type blade retainer 88 structures.

In some embodiments, a blade retainer may be used wherein the datum surface 97 is disposed to contact one or more blades within the blade cartridge 20. For example, the blades may be biased (e.g., spring mounted) so that portions of the cutting edge of the blade(s) are biased against the datum surface 97, thereby providing a locating surface for the razor blade.

The first blade group 26, second blade group 28, and the guard bar 30 are disposed between the forward cap 70 and the aft cap 72. When the shave cartridge 20 is translated past a point on the surface in a forward stroke direction (indicated as arrow 96 in FIG. 3), the shave cartridge 20 elements will pass the point on the surface in the following order: the forward cap 70, the second blade group 28, the guard bar 30, the first blade group 26, and then the aft cap 72. Conversely, when the shave cartridge 20 is translated past the point on the surface in a reverse stroke direction (indicated as arrow 98 in FIG. 3), the elements will pass the point on the surface in the following order: the aft cap 72, the first blade group 26, the guard bar 30, the second blade group 28, and then the forward cap 70.

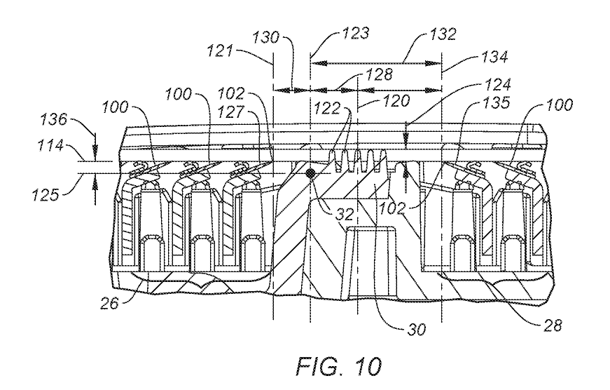

Now referring to FIG. 9, each of the first and second blade groups 26, 28 includes at least one blade 100 having a cutting edge 102. In those embodiments wherein the first blade group 26 includes two or more blades 100, the blade 100 closest to the guard bar 30 may be referred to as the first blade 100F (also blade 127 in FIG. 10), and the blade within the first blade group 26 next closest to the guard bar 30 is referred to herein as the second blade 100S, and the blade within the first blade group 26 next closest to the guard bar 30 is referred to herein as the third blade 100T, etc. similarly, in those embodiments wherein the second blade group 28 includes two or more blades 100, the blade closest to the guard bar 30 is referred to herein as the first blade 100F (also blade 135 in FIG. 10), and the blade within the second blade group 28 next closest to the guard bar 30 is referred to herein as the second blade 100S, etc. In a preferred embodiment, the first blade group 26 (which is engaged in the “forward” or “pull” stroke) includes a greater number of blades than the second blade group 28 (which is engaged in the “reverse” or “push” stroke). The embodiments shown in FIGS. 3-5 include three blades in the first blade group 26 and two blades in the second blade group 28. Analysis to date suggests this configuration works well. However, the present disclosure is not limited to this particular blade configuration.

The first and second blade groups 26, 28 are oriented relative to one another within the shave cartridge 20 so only one of the blade groups 26, 28 will engage hairs on the hirsute surface when the shave cartridge 20 is translated in a given stroke direction. For example, when the shave cartridge 20 is translated in the forward stroke direction, the first blade group 26 will engage and cut hair extending out from the surface and the second blade group 28 will not engage hair extending out from the surface in a manner intended to cut hair. Conversely, when the shave cartridge 20 is translated in the reverse stroke direction, the second blade group 28 will engage and cut hair extending out from the surface and the first blade group 26 will not engage hair extending out from the surface in a manner intended to cut hair.

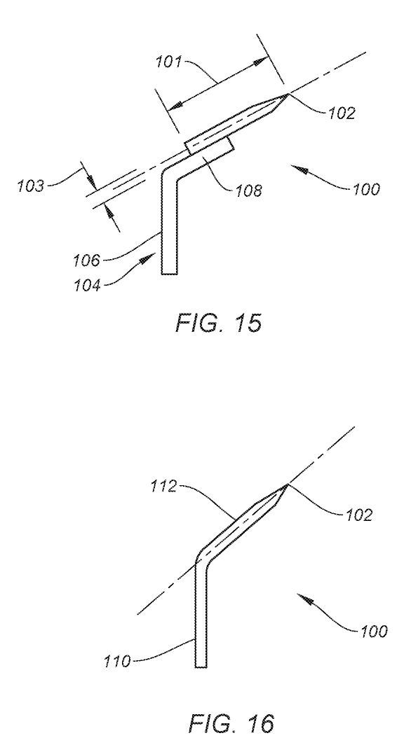

Now referring to FIGS. 15 and 16, each blade 100 has a width 101, a length (extending into the page), and a thickness 103. The cutting edge 102 extends along one lengthwise extending edge of the blade 102 and is configured as a decreased thickness portion of the blade that is able to shear hair brought into contact with the cutting edge 102. The present disclosure is not limited to any particular type of blade. A first example of an acceptable blade 100 is planar blade 100 mounted (e.g., welded) on a support member 104 as shown in FIG. 15. The support member 104 may include a first portion 106 and a second portion 108, which portions are “bent” relative to one another so as to be non-planar. The planar blade 100 is mounted on the second portion 108 of the support member 104. A second example of an acceptable blade is “bent” blade as shown in FIG. 16; e.g., a blade 100 having a body with integral first and second portions 110, 112 disposed at an angle relative to one another such that the first and second portions 110, 112 do not reside within the same lengthwise extending plane. The cutting edge 102 is disposed on the second blade portion 112, and the opposite first portion 110 is secured within the shave cartridge 20. U.S. Pat. No. 7,681,314 and US Patent Application publication 2010/0107425, which are both hereby incorporated by reference in their entireties, discloses examples of blades that may be utilized within the present shave cartridge 22.

Referring to FIG. 9, in some embodiments the present cartridge may include one or more inter-blade guards 158. Each inter-guard blade 158 includes a skin-engaging surface 160 and is disposed between two (2) neighboring blades (e.g., blades 100F and 100S as shown in FIG. 9). The inter-blade guard 158 is disposed such that the skin-engaging surface 160 is located substantially near the reference plane 114 during normal shaving operation. The inter-blade guard 158 may have any suitable cross-sectional shape; e.g., the inter-blade guards 158 shown in FIG. 9 have a curved cross-sectional shape. U.S. Pat. No. 7,681,314, which is hereby incorporated by reference in its entirety, discloses inter-blades guards 158 that may be used with the present cartridge.

Now referring to FIG. 9, in those embodiments wherein a blade group 26, 28 includes two or more blades, the blades 100 are spaced apart from one another (e.g., by a spacer) by an inter-blade spacing distance. The inter-blade spacing distance is defined as the distance between cutting edges 102 of adjacent blades. A blade group having two or more blades may be described as having a first inter-blade spacing distance (“1BS”) between the cutting edges of the first and second blades, a second inter-blade spacing distance (“2BS”) between the cutting edges of the second and third blades, etc. The inter-blade spacing distances may be the same (i.e., 1BS=2BS) or different (1BS≠2BS). The inter-blade spacings between blades in the first blade group 26 and the inter-blade spacings between the blades in the second blade group 28 may be the same or may be different.

Now referring to FIGS. 10 and 11, the cutting edges 102 of the blades 100 within the first and second blade groups 26, 28 are disposed proximate a plane 114 (referred to hereinafter as the “reference plane 114”). The reference plane 114 is tangential to both of the cutting edge 102 of the first blade (100F, 127) of the first blade group 26 and the cutting edge 102 of the first blade 135 of the second blade group 28.

Now referring to FIG. 10, in some embodiments the cutting edges 102 of the blades in both blade groups 26, 28 are co-planar; i.e., the reference plane 114 is tangential to all of the blade cutting edges 102 in both blade groups when the shave cartridge 20 blades are in their normal position. The term “normal” as used here means that the blades 100 are at rest, with no external force applied to the blades.

In some embodiments, the cutting edges 102 of the blades in the first blade group 26 are co-planar; i.e., the reference plane 114 is tangential to all of the blade cutting edges 102 when in the first blade group 26 when the shave cartridge 20 is in a normal condition. In some embodiments, the cutting edges 102 of the blades in the second blade group 28 are co-planar, which plane may be parallel to the reference plane 114. In some embodiments, one or more cutting edges 102 in the first and/or second blade group 28 may be disposed above the reference plane 114 (which positioning is sometimes referred to as an “aggressive” cutting edge position), and/or one or more cutting edges may be disposed below the reference plane 114. The present shave cartridge 20 is not limited to any particular cutting edge 102 configuration. For those embodiments wherein one or more blades 100 are mounted within the shave cartridge 20 in a manner that allows the blade to elastically deflect from its normal position (e.g., spring mounted blades), the position of the blade cutting edge 102 of the deflected blade 100 may change during use of the shave cartridge 20 as the user applies the shave cartridge 20 to the surface to be shaved.

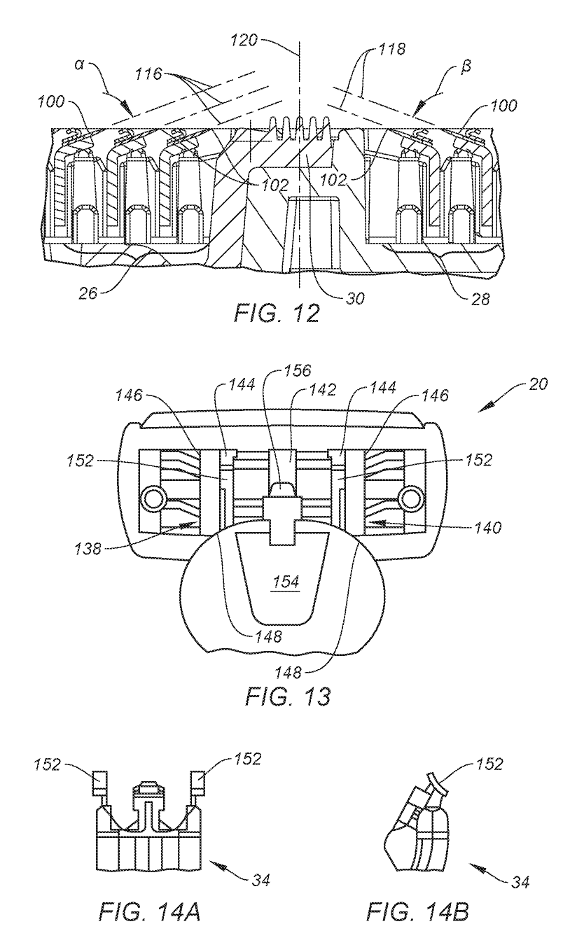

Now referring to FIG. 12, in those embodiments wherein the first blade group 26 includes more than one blade 100, all of the blades 100 within the first blade group 26 are oriented similarly. For example, the cutting edges 102 of all the blades within the first blade group 26 all extend lengthwise and all cutting edges point in substantially the same direction; e.g., a line 116 extending through the widthwise centerline of any blade 100 within the first blade group 26 (and through the cutting edge 102 of that blade) extends generally in a direction toward the second blade group 28 and will pass over the second blade group 28. The aforesaid blade orientation within the first blade group 26 may be described in terms of the included angle “a” between the line 116 extending through the widthwise centerline of the respective blade and the reference plane 114.

In those embodiments wherein the second blade group 28 includes more than one blade 100, all of the blades within the second blade group 28 are oriented similarly. For example, the cutting edges 102 of all the blades 100 within the second blade group 28 all extend lengthwise and all cutting edges 102 point in substantially the same direction; e.g., a line 118 extending through the widthwise centerline of any blade 100 within the second blade group 28 (and through the cutting edge 102 of that blade) extends generally in a direction toward the first blade group 26 and will pass over the first blade group 26. The aforesaid blade orientation within the second blade group 28 may be described in terms of the included angle “β” between the line 118 extending through the widthwise centerline of the respective blade 100 and the reference plane 114. The magnitude of angles α and β may be the same or different.

FIGS. 3, 4, 9, 10, and 12 depicts a center plane 120 that extends in a depthwise direction (e.g., along the Z-axis) and lengthwise (e.g., along the X-axis), perpendicular to the reference plane 114 disposed in the X-Y plane when the shave cartridge is in a normal position as shown in FIGS. 2-4. The center plane 120 is located at the midpoint (i.e., equidistant) between the cutting edge 102 of the first blade (100F, 127) of the first blade group 26 and the cutting edge 102 of the first blade (100F, 135) of the second blade group 28.

The guard bar 30 may assume a variety of different configurations, and is not therefore limited to any particular configuration. The guard bar 30 embodiment shown in FIGS. 9 and 10, for example, is formed from a relatively pliable polymer material (e.g., a thermoplastic polymeric elastomer) and includes a plurality of surface features (e.g., ribs 122) that extend outwardly from a body. The guard bar 30 is not limited to any particular surface feature configuration. In some embodiments (e.g., see FIGS. 9 and 10), the guard bar 30 includes ribs 122 that extend lengthwise the entirety of the guard bar 30 and may be parallel to the cutting edges of the blades. In other embodiments, the ribs 122 may be arranged in a herringbone pattern, or may include a variety of different types of features, etc. The surface features typically extend outwardly to a position above the reference plane 114 (e.g., FIG. 10 shows the distance 124 that the ribs 122 extend above the reference plane 114) and are configured to engage the skin surface of the user to stretch the skin surface and orient the skin surface for shaving. The guard bar 30 is preferably configured to operate bi-directionally; e.g., to create a desirable skin orientation when the shave cartridge 20 is moved in a forward/pull stroke direction as well as a reverse/push stroke direction.

The shave cartridge 20 may include a comfort strip 126 disposed in (or attached to) one or both of the forward and aft caps 70, 72 (e.g., see FIG. 2). The shave cartridge 20 may also include a comfort strip 126 disposed in (or attached to) one or both first and second lateral surfaces 74, 76. The comfort strip 126 may include one or more shaving aids (e.g., lubricating agents, drag reducing agents, depilatory agents, cleaning agents, medicinal agents, etc.) that are deposited on the skin surface to enhance the shaving process. In some embodiments, the entire exterior contact surface of the forward cap 74 or the aft cap 76, or both may be covered with a comfort strip material; e.g., FIG. 5 shows an embodiment where the forward and aft caps 74, 76 are comprised of a comfort strip material. The present disclosure is not limited to any particular comfort strip configuration and/or composition.

Now referring to FIG. 10, as indicated above the shave cartridge 20 is configured to have a non-centered lengthwise extending pivot axis 32 about which the shave cartridge 20 can pivot. The non-centered lengthwise extending pivot axis 32 (shown at the intersection of lines 123 and 125) is located offset from the center plane 120 and widthwise between the center plane 120 and a line 121 tangential to the cutting edge 102 of the first razor blade 127 of the first blade group 26, which tangential line 121 is parallel to the center plane 120. In this position, the pivot axis 32 may be described as being “forward” of the first blade (e.g., 100F, 127) of the first blade group 26. In the context of the present disclosure a first blade of any of the first blade group 26 and second blade group 28 is that blade closest to the center plane 120. A second blade is the next adjacent blade in a direction away from the center plane 120. A last blade of any blade group is the blade furthest from the center plane 120. In preferred embodiments, the pivot axis 32 is located a distance 128 in the range of about 0.6-1.8 mm from the center plane 120, and a distance 130 in the range of about 1.6-0.4 mm from the line 121 tangential to the cutting edge 102 of the first razor blade 127 of the first blade group 26. The sum of the distance 128 between the center plane 120 and the pivot axis 32 and the distance 130 between the pivot axis 32 and the line 121 tangential to the cutting edge 102 of the first razor blade 127 of the first blade group 26 equals the distance between the center plane 120 and the line 121 tangential to the cutting edge 102 of the first razor blade 127 of the first blade group 26. In contrast, the distance 132 between the pivot axis 32 and a line 134 tangential to the cutting edge 102 of the first razor blade 135 of the second blade group 28, which tangential line 134 is parallel to the center plane 120, is greater than the distance 130 between the pivot axis 32 and the line 121 tangential to the cutting edge 102 of the first razor blade 127 of the first blade group 26. Hence, the widthwise distance 130 between the pivot axis 32 and the cutting edge 102 of the first blade 127 of the first blade group 26 is less than the widthwise distance 132 between the pivot axis 32 and the cutting edge 102 of the first blade 135 of the second blade group 28. In some embodiments, a distance between the pivot axis 32 and the cutting edge 102 of the outermost blade of the first blade group 26 (e.g., See blade 100T in FIG. 9) is less than the distance between the pivot axis 32 and the cutting edge 102 of the outermost blade of the second blade group 28 (e.g., See blade 100S in FIG. 9). In some embodiments, the distance between the pivot axis 32 and the cutting edge 102 of the first blade of the first blade group (e.g., See blade 100F in FIG. 9) is less than the distance between the center plane 120 and the cutting edge 102 of the first blade of either blade group 26, 28.

In other embodiments pivot axis 32 is located widthwise offset from the center plane 120 and between the center plane 120 and a line tangential to the cutting edge 102 of the second razor blade 100S of the first blade group 26, which tangential line 121 is parallel to the center plane 120. The pivot axis can be closer to the cutting edge of the first razor blade of the first blade group than the cutting edge of the second razor blade of the first blade group. In further embodiments pivot axis 32 is located widthwise offset from the center plane 120 and between the center plane 120 and a line tangential to the cutting edge 102 of the last razor blade of the first blade group 26, which tangential line 121 is parallel to the center plane 120. The pivot axis can be closer to the cutting edge of the first razor blade of the first blade group than the cutting edge of the last razor blade of the first blade group.

As shown in FIGS. 3, 4, 9, and 10, in some embodiments the pivot axis 32 may be disposed below the reference plane 114. In these embodiments, the pivot axis 32 is typically disposed a distance 136 in the range of 0.1-0.5 mm from the reference plane 114, but no more than about 1.5 mm below the reference plane 114. In alternative embodiments, the pivot axis 32 may be disposed within or above the reference plane 114.

The position of the pivot axis 32 within the present shave cartridge 20 provides substantial advantages that are apparent during operation of the present shave cartridge 20. For example, disposing the pivot axis 32 a depthwise distance 136 from the reference plane 114 (or less) as described above, provides advantageous controlled movement of the shave cartridge 20 in the forward and rearward stroke directions. It is our experience that a pivot axis 32 located a distance below the reference plane 114 beyond the aforesaid depthwise distance 136 decreases the stability of a bidirectional shave cartridge 20, and can lead to a shave cartridge 20 “chattering” as it is translated across a skin surface.

Disposing the pivot axis 32 widthwise between the first blade 127 of the first blade group 26 and the center plane 120 accommodates force differences typically encountered in the forward stroke direction versus those encountered in the reverse stroke direction. Specifically, during the “push” stroke (i.e., the reverse stroke direction) there is a tendency for the user to apply the shave cartridge 20 to the skin surface with a greater normal force than is used during the “pull” stroke (i.e., the forward stroke direction). The increased distance between the pivot axis 32 and the cutting edge of the first blade of the second blade group 28 (distance 132>distance 130) tends to decrease the amount of normal force resultant at the first blade 135 of the second blade group 28 (which resultant force is a function of the force applied by the user at the pivot axis 32 and the “pivot arm” distance 132 between the cutting edge 102 of the first blade 135 of the second blade group 28 and the pivot axis 32). Hence, even if the user applies exactly the same amount of normal force at the pivot axis 32 for a forward and reverse stroke, the amount of normal force resultant at the first blade 135 of the second blade group 28 is less during a reverse stroke than would be present at the first blade 127 of the first blade group 26 during a forward stroke.

The position of the guard bar 30 relative to the “offset” pivot axis 32 and the first blades of the first and second blade groups 26, 28 also provides desirable skin surface orientation. For example, when the shave cartridge 20 is drawn in the forward stroke direction, the guard bar 30 acts on the skin causing the skin encountered by the first blade group 26 to stretch slightly and assume a more planar orientation that it would in the absence of the guard bar 30. At the same time, the skin surface aft of the guard bar 30 (i.e., between the guard bar 30 and the second blade group 28) can develop a slight bulge that may extend toward the reference plane 114. The offset pivot axis 32 creates a smaller bulge than would be formed with a non-offset pivot axis 32 and thereby enable the skin surface to more readily assume a desirable skin surface orientation. Hence, the offset pivot axis 32 arrangement relative to the guard bar 30 helps to protect the user during the pull-push transition while allowing the user to maintain the shave cartridge 20 engaged with the skin surface.

The present shave cartridge 20 may establish the non-centered pivot axis 32 in a variety of different configurations, and is therefore not limited to any particular configuration. An example of a configuration operable to establish the non-centered pivot axis 32 at the location described above can be seen in FIGS. 1-4, 13, 14A, and 14B. In this exemplary embodiment, the shave cartridge 20 includes a first flange 138 and a second flange 140 extending out from the handle attachment side 31 of the shave cartridge 20, and a cam surface 142. Each flange 138, 140 includes an inner surface 144 and an outer surface 146. Each flange 138, 140 further includes at least one arcuate bearing surface 148 disposed on the inner surface 144, and an arcuate slot 150 (see FIGS. 3 and 4) disposed in the inner surface 144. The cam surface 142 is disposed between the first and second flanges 138, 140. The handle 34 includes a pair of arcuately shaped tabs 152, each of which is configured to be received in the arcuate slot 150 of the respective flange 138, 140. The tabs 152 are biased outwardly to a normal position. In the normal position, and when the shave cartridge 20 is mounted on the handle 34, the tabs 152 (which are arcuately shaped to mate with the respective arcuate slot 150) are received within the respective slot 150. The handle 34 includes a mechanism 154 for moving the tabs 152 inwardly to a position where they are not engaged with the slots 150, and the shave cartridge 20 can be detached from the handle 34. To mount a new shave cartridge 20 on the handle 34, the tabs 152 are moved inwardly and the shave cartridge 20 is positioned so that the tabs 152 are aligned with the slots 150. The user releases the mechanism 154 and the tabs 152 return to their normal position where they are received with the slots 150. The handle 34 includes bearing surfaces that mate with the flange bearing surfaces 148. The handle 34 further includes a biased cam follower 156 that acts against the cam surface 142. The cam follower 156 biases the shave cartridge 20 into a normal position. The flange bearing surfaces 148 and the mating arcuate tabs 152 and slots 150 are configured to rotate the shave cartridge 20 about the pivot axis 32. U.S. Pat. No. 7,331,107, which is hereby incorporated by reference in its entirety, discloses a shave cartridge pivotal mounting arrangement similar to that described above. The handle connector portion 64 included with the shave cartridge 20 embodiment shown in FIGS. 2 and 3 is configured to pivot in the manner described above. The handle 34 is attachable to the handle connector portion 64. As stated above, the above described shave cartridge pivotal mounting arrangement is an example of an arrangement that can be used to accomplish pivoting of the shave cartridge 20 about the pivot axis 32, and the present disclosure is not limited to this example.

As will be recognized by those of ordinary skill in the pertinent art, numerous modifications and substitutions may be made to the above-described embodiment of the present invention without departing from the scope of the invention as set forth in the appended claims. For instance, features disclosed in connection with any one embodiment can be used alone or in combination with each feature of the respective other embodiments. Accordingly, the preceding portion of this specification is to be taken in an illustrative, as opposed to a limiting sense.

1. A pivotal bi-directional shave cartridge configured to shave a hirsute skin surface in a first direction and a second direction, which second direction is substantially opposite the first direction, comprising:
a housing having a width, a length, a shave side, and a handle attachment side;
a first blade group including at least a first razor blade having a cutting edge, which first blade group is configured to shave the skin surface when the shave cartridge is translated in the first direction;
a second blade group including at least a first razor blade having a cutting edge, which second blade group is configured to shave the skin surface when the shave cartridge is translated in the second direction; and
a guard bar disposed between the first blade group and the second blade group;
wherein a lengthwise extending center plane is disposed equidistant between the cutting edge of the first razor blade of the first blade group and the cutting edge of the first razor blade of the second blade group, and wherein the center plane is perpendicular to a reference plane that is tangential to both the cutting edge of the first razor blade of the first blade group and the cutting edge of the first razor blade of the second blade group; and
wherein the shave cartridge is configured to pivot about a pivot axis, and the pivot axis is disposed between the center plane and a plane tangential to the cutting edge of the first razor blade of the first blade group, which plane is parallel to the center plane.

2. The cartridge of claim 1, wherein the pivot axis is closer to the cutting edge of the first razor blade of the first blade group than the center plane.

3. A pivotal bi-directional shave cartridge configured to shave a hirsute skin surface in a first direction and a second direction, which second direction is substantially opposite the first direction, comprising:
a housing having a width, a length, a shave side, and a handle attachment side;
a first blade group including at least a first razor blade and a second razor blade, each having a cutting edge, which first blade group is configured to shave the skin surface when the shave cartridge is translated in the first direction;
a second blade group including at least a first razor blade having a cutting edge, which second blade group is configured to shave the skin surface when the shave cartridge is translated in the second direction; and
a guard bar disposed between the first blade group and the second blade group;
wherein a lengthwise extending center plane is disposed equidistant between the cutting edge of the first razor blade of the first blade group and the cutting edge of the first razor blade of the second blade group, and wherein the center plane is perpendicular to a reference plane that is tangential to both the cutting edge of the first razor blade of the first blade group and the cutting edge of the first razor blade of the second blade group; and
wherein the shave cartridge is configured to pivot about a pivot axis, and the pivot axis is disposed between the center plane and a plane tangential to the cutting edge of the second razor blade of the first blade group, which plane is parallel to the center plane.

4. The cartridge of claim 3, wherein the pivot axis is closer to the cutting edge of the first razor blade of the first blade group than the cutting edge of the second razor blade of the first blade group.

5. A pivotal bi-directional shave cartridge configured to shave a hirsute skin surface in a first direction and a second direction, which second direction is substantially opposite the first direction, comprising:
a housing having a width, a length, a shave side, and a handle attachment side;
a first blade group including at least a first razor blade and a last razor blade, each having a cutting edge, which first blade group is configured to shave the skin surface when the shave cartridge is translated in the first direction;
a second blade group including at least a first razor blade having a cutting edge, which second blade group is configured to shave the skin surface when the shave cartridge is translated in the second direction; and
a guard bar disposed between the first blade group and the second blade group;
wherein a lengthwise extending center plane is disposed equidistant between the cutting edge of the first razor blade of the first blade group and the cutting edge of the first razor blade of the second blade group, and wherein the center plane is perpendicular to a reference plane that is tangential to both the cutting edge of the first razor blade of the first blade group and the cutting edge of the first razor blade of the second blade group; and
wherein the shave cartridge is configured to pivot about a pivot axis, and the pivot axis is disposed between the center plane and a plane tangential to the cutting edge of the last razor blade of the first blade group, which plane is parallel to the center plane.

6. The cartridge of claim 5, wherein the pivot axis is closer to the cutting edge of the first razor blade of the first blade group than the cutting edge of the last razor blade of the first blade group.

7. The cartridge of claim 5, wherein the pivot axis is disposed a distance no more than 0.5 mm from the reference plane in a direction toward the handle attachment side.

8. The cartridge of claim 5, wherein both the cutting edge of the razor blade of the first blade group and the cutting edge of the first razor blade of the second blade group face the center plane.

9. The cartridge of claim 5, wherein the first blade group includes a first number of razor blades and the second blade group includes a second number of razor blades, and the first number of razor blades is different than the second number of blades.

10. The cartridge of claim 9, wherein the first number of razor blades is greater than the second number of razor blades.

11. The cartridge of claim 5, wherein at least one razor blade of the second blade group includes a skin engaging member attached to the razor blade.

12. The cartridge of claim 5, wherein at least one razor blade of the first blade group includes a skin engaging member attached to the razor blade.

13. The cartridge of claim 5, wherein the guard bar includes surface features, which features are disposed between the pivot axis and the second blade group.

14. The cartridge of claim 13, wherein the surface features extend through the reference plane.

15. The cartridge of claim 5, wherein the pivot axis is disposed in the reference plane.

16. The cartridge of claim 5, wherein the pivot axis is disposed above the reference plane.

17. The cartridge of claim 5, wherein the first blade group, the second blade group, and the guard bar are mounted within a razor cartridge, which razor cartridge is mounted within the housing.

18. The cartridge of claim 5, further comprising a forward cap and an aft cap.

19. The cartridge of claim 5, wherein the at least first razor blade having a cutting edge of the first blade group is a plurality of razor blades each having a cutting edge, and the cutting edges of the razor blades are co-planar within a first plane.

20. The cartridge of claim 19, wherein the at least first razor blade having a cutting edge within the second blade group is a plurality of razor blades each having a cutting edge, and the cutting edges of the razor blades are co-planar within a second plane.

21. The cartridge of claim 20, wherein the first plane and the second plane are co-planar.

22. (canceled)

23. The cartridge of any of claim 5, wherein the housing has opposed lateral portions and wherein the opposed lateral portions each include an indented lateral portion.

24. (canceled)
